(19) United States
(12) Patent Application Publication
(10) Pub. No.: US 2010/0089694 A1
(43) Pub. Date: Apr. 15, 2010

(54) POLE CLIMBING AND FALL RESTRAINT DEVICE AND KIT

(76) Inventor: Roderick Paul, Mercer, PA (US)

Correspondence Address: BUCHANAN INGERSOLL & ROONEY PC, P.O. BOX 1404, ALEXANDRIA, VA, 22313-1404, US

(21) Appl. No.: 12/252,611

(22) Filed: Oct. 16, 2008

Related U.S. Application Data
(60) Provisional application No. 61/103,961, filed on Oct. 9, 2008.

(51) Int. Cl. A62B 35/00

(52) U.S. Cl. 182/9

(57) ABSTRACT

A pole climbing and fall restraint device is disclosed that includes a belt device and a lanyard apparatus. The belt device and lanyard apparatus may be connected to each other or sold separately. The lanyard apparatus and belt device may also be provided in a kit and sold together or sold separately. The lanyard apparatus includes an elongated member extending through a locking device and a coupling connected to the elongated member. At least one handle is connected to the elongated member. The belt device includes a first connector and a second connector attached to the belt device. A first strap extends from the first connector and a second strap extends from the second connector. A third connector is attached to the first and second straps adjacent the front portion of the belt device

### CROSS-REFERENCE TO RELATED APPLICATIONS

The present application claims the benefit under 35 U.S.C. § 119(e) of U.S. Provisional Patent Application Ser. No. 61/103,961 which was filed on Oct. 9, 2008

### FIELD OF INVENTION

The present invention relates to pole climbing and fall restraint safety harnesses, safety belts and the like that are worn to prevent falls.

### BACKGROUND OF THE INVENTION

Safety restraint devices used to prevent falls are often used by workers or hunters to prevent accidents or injury when climbing tall objects such as trees or utility poles Examples of such safety devices are disclosed in U.S. Pat. Nos. 4,923,048, 4,991,689, 5,052,514, 5,137,113, 6,241,045, 6,752,242 and 6,981,571. These devices typically include a belt or harness worn by a user and a rope that has at least one end connected to the belt or harness.

Many safety restraint devices require a user to position a rope around the circumference of a utility pole and connect one end of the rope to another portion of the rope such that the rope forms a loop that totally encircles the pole or trunk. Such loops are often difficult to adjust when a user climbs up the pole because the rope is normally in tight, frictional engagement with the pole. As a result, it is often difficult to adjust the position of the loop as a user reaches higher positions on the pole he or she is climbing. To make readjustment of the loop easier and climbing occur at a faster rate, users may disconnect the rope to reposition the loop formed by the connected rope, which increases the user's exposure to injury because the safety device is unable to prevent a fall until the rope has been reconnected by the user to reform the loop.

To climb tip a pole, a user typically must loosen the loop from its tight fit around the pole by providing additional rope length to introduce slack that can be taken up as the user climbs a pole. In some devices, the rope that a user must manipulate to move the loop encircling a pole has an end connected to a holder that slides along the rope, such as the devices disclosed in U.S. Pat. Nos. 4,923,048 and 4,991,689. If a user wishes to provide slack without disconnecting the rope, such sliding devices require the climber to introduce the necessary slack into the rope by reducing the distance between the user and the pole. Such a reduction of distance is often obtained by tightly hugging the pole as the pole is climbed. Such hugging can slow the rate at which a user may climb the pole.

Further, a climber must often readjust the position of the loop when climbing the pole. The time needed to readjust the position of the loop increases the time needed for the user to climb the pole Readjustment of the position of the loop can be difficult and significantly time consuming due to the small diameter of the rope and its tight fit around the pole.

Some safety restraints, such as the belt disclosed in U.S. Pat. No. 5,137,113, require a user to adjust the length of the loop by manipulating a locking device located at the side of a user to an unlocked position. If the locking device is not properly reset to its locked position, the locking device may not lock the position of the rope, which can permit a user to accidentally fall without any functioning restraint. The positioning of such devices make them difficult for a user to see, which can prevent the user from properly manipulating the locking device or easily verifying that the locking device has been properly reset to its locked position as the user climbs up a pole or performs work at a given position on the pole. As a result, users often stop their work for substantial periods of time to verify that the locking device they cannot see is properly set.

Because locking devices are often not positioned directly in front of the user, the user normally has to turn his or her head or take other action to maneuver the user's eyes so the user can see the locking device. Due to the fear of falling, such verification can occur multiple times when working on a project, which may greatly increase the time needed to complete a task or project. The concerns related to the setting of the locking device may linger with a user as he or she performs the work, which can impair the user's ability to perform his or her work. For example, such lingering concern can detrimentally affect the quality of the work being performed and the time needed to perform such work. Such concerns are typically heightened if a user must make substantial movements to verify the setting of the locking device because such substantial movements could cause the user to fall while the user is not certain the locking device is properly set to prevent such a fall.

A pole climbing and fall restraint device is needed that permits a user to easily reposition the loop surrounding a pole as he or she climbs the pole. Preferably, such a device should also be configured to permit a user to easily adjust the length of the loop by manipulating a locking device. The locking device should be positioned so it can easily be seen by a user as he or she climbs a pole or performs work at a given position on a pole so the user can quickly and easily verify the locking device is set to lock the rope forming the loop.

### SUMMARY OF THE INVENTION

I provide a pole climbing and fall restraint device that includes an elongated member extending through a locking device, a coupling attached to the elongated member, a first handle attached to the elongated member and a second handle attached to the elongated member. The elongated member is sized and configured to adjustably wrap around a pole. The elongated member has a first end, a second end and a middle portion between the first end and second end. The coupling is attached to the first end of the elongated member. The coupling is configured to releasably attach to the middle portion of the elongated member. The first handle is attached to the elongated member such that the first handle extends a first distance from the elongated member. The second handle is attached to the elongated member such that the second handle extends a second distance from the elongated member. The first distance is greater than the second distance.

In some embodiments, the first handle or second handle may be a J-hook or, other hook. Such hooks may be attached to the elongated member by a strap or other connecting device such that the hooks are configured to rotate about the elongated member. The first handle and second handle may be attached to the elongated member such that the first and second handles are moveable along the elongated member.

Preferably, the elongated member is a rope, a wire or a strap

Embodiments of my pole climbing and fall restraint device may also include at least one stop attached to the elongated member. For example, the one or more stops can include a first stop positioned between the first handle and the second handle, a second stop attached to the middle portion of the elongated member, or both a first and second stop. The first stop and second stop may be moveable along the elongated member. The first stop is preferably sized and configured to help limit movement of the first handle, second handle. The second stop is preferably sized and configured to help limit movement of the coupling when it is attached to the middle portion of the elongated member.

At least one engaging device can be attached to the one or more stops. The one or more engaging devices can include a first engaging device configured to engage or pierce a pole. In some embodiments, one or more of the engaging devices can include a nail, a screw, a bolt, a hook, one or more saw teeth, or a rough surface.

I also provide a pole climbing and fall restraint device that includes a belt, a first connector connected to the belt, and a second connector connected to the belt A first strap extends from the first connector adjacent the front portion of the belt and a second strap extends from the second connector adjacent the front portion of the belt A third connector is connected to the first strap and the second strap adjacent the front portion of the belt. A locking device is connected to the third connector. An elongated member extends through the locking device. A coupling is connected to the elongate member. The first strap extends a first distance from the first connector and the second strap extends a second distance from the second connector. The first distance and the second distance are substantially equal.

In some embodiments, the elongated member has a first end, a middle portion and a second end and the coupling is connected to the first end. The coupling can be configured to slidably retain a part of the middle portion of the elongated member when the coupling connects the first end of the elongated member to a part of the middle portion of the elongated member.

In other embodiments, the belt can also include a buckle configured to adjustably fasten the belt about a user. The locking device can be connected to the third connector such that the locking device is positioned adjacent to and forward of the buckle.

Preferably, the belt has a front middle portion and the locking device is connected to the third connector such that the locking device is positioned adjacent to and forward of the front middle portion of the belt when the belt is fastened.

I additionally provide a pole climbing and fall restraint kit that includes a belt device and a lanyard apparatus configured for attachment to the belt device. The belt device includes a first connector and a second connector connected to the belt device A first strap extends from the first connector adjacent the front portion of the belt device and a second strap extends from the second connector adjacent the front portion of the belt device. A third connector is connected to the first strap and the second strap adjacent the front portion of the belt device.

The lanyard apparatus includes an elongated member that is sized and configured to adjustably wrap around a pole. The elongated member has a first end, a second end and a middle portion between the first end and second end. A coupling is attached to the first end of the elongated member. The coupling is configured to releasably attach to the middle portion of the elongated member. A first handle is attached to the elongated member such that the first handle extends a first distance from the elongated member. A second handle is attached to the elongated member such that the second handle extends a second distance from the elongated member. The first distance is greater than the second distance.

The lanyard apparatus is configured to be connected to a locking device that is attachable to the belt device. In some embodiments of my kit, the locking device is provided with the belt device. In other embodiments of my kit, the locking device may be provided with the lanyard apparatus. In yet additional embodiments of my kit, the locking device may be provided separately.

Other details, objects, and advantages of the invention will become apparent as the following description of certain present preferred embodiments thereof proceeds.

### BRIEF DESCRIPTION OF THE DRAWINGS

In the accompanying drawings I have shown certain present preferred embodiments of my pole climbing and fall restraint device in which:

FIG. 1 is a perspective view of a first present preferred embodiment of my pole climbing and fall restraint device.

FIG. 2 is a perspective view of the handles and a portion of the rope of the first present preferred embodiment illustrated in FIG. 1

FIG. 3 is a perspective view of the belt, straps, connectors, and locking device of the first present preferred embodiment shown in FIG. 1, illustrating the locking device in an unlocked position.

FIG. 4 is a view similar to FIG. 3, illustrating the locking device in a locked position.

FIG. 5 is a perspective top view of the first present preferred embodiment being worn by a user positioned on a pole.

FIG. 6 is a perspective view of a second present preferred embodiment of my pole climbing and fall restraint device.

FIG. 7 is a fragmentary view of the second present preferred embodiment

FIG. 8 is a perspective top view of the second present preferred embodiment being worn by a user positioned on a pole.

### DETAILED DESCRIPTION OF PRESENT PREFERRED EMBODIMENTS

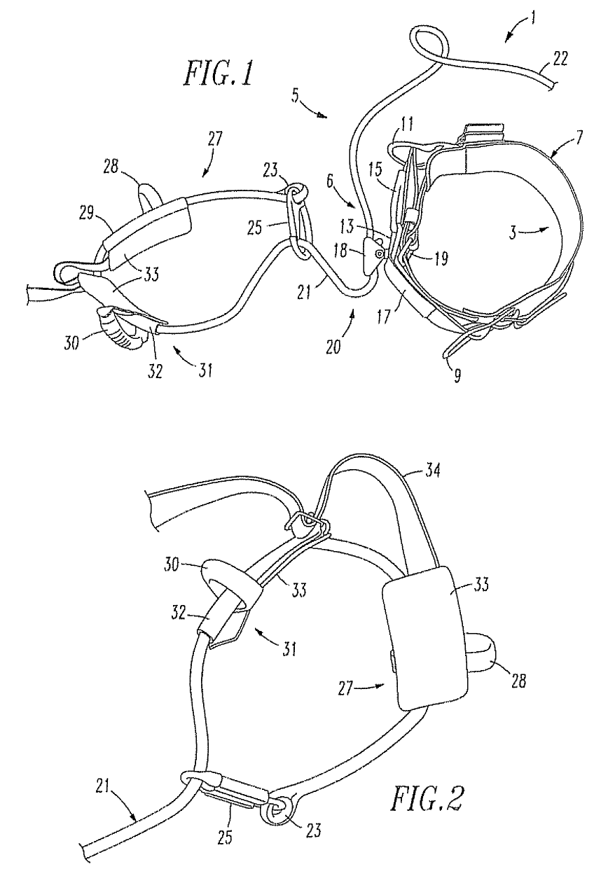

A first present preferred embodiment 1 of my pole climbing and fall restraint device is shown in FIGS. 1-5. The embodiment 1 has a belt 3 that has a rear portion 7 and a front portion 5. The belt 3 also has a belt buckle 19 at the middle front portion 6 of the belt. The belt has n first connector 9 attached to the belt adjacent to the first side of the belt buckle and has a second connector 11 attached to the belt 3 adjacent to an opposite second side of the belt buckle. A First strap 17 extends from the first connector 9 to a third connector 13. A second strap 15 extends from the second connector 11 to the third connector 13. A locking device 18 is connected to the third connector. The second strap 15 and first strap 17 connect the third connector 13 and the locking device 18 to the belt 3. Rope 20 passes through the locking device 18

I prefer that connectors 9 and 11 be D rings and that connector 13 be a triple lock carabiner. Of course, various other fasteners or connectors may also be used.

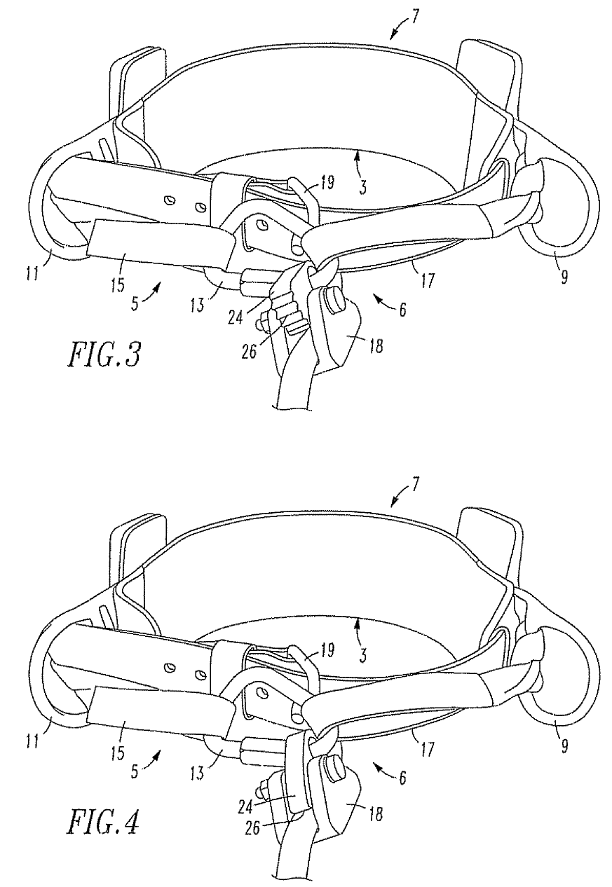

The locking device 18 has a cam 24 that has teeth 26 configured to engage the rope 20. When the locking device 18 is moved to a located position, shown in FIG. 4, the teeth 26 of the cam 24 engage the rope 20, preventing the rope from moving through the cam. When the locking device is an unlocked position, shown in FIG. 3, the rope may pass through the locking device.

The rope 20 has a first end 23, a middle portion 21 and a second end 22. A clip 25 is attached to the first end 23 of the rope. The clip 25 is configured to connect to the middle portion 21 of the rope such that the clip 25 can slide along the middle portion 21 of the rope.

A first handle 27 and a second handle 31 are attached to the middle portion 21 of the rope. The first handle has a hand grasping member 28 and a tube 29 that has a bore sized and configured to slidably receive the rope 20. Tube 29 permits a user to move the first handle 27 along the middle portion 21 of the rope. The second handle 31 also has a grasping member 30 and a tube 32. Tube 32 has a bore that is sized and configured to slidably receive the lope 20 so a user can move the second handle 31 along the middle portion 21 of the rope Tubes 29 and 32 may be composed of plastic, leather, canvas or any combination thereof. I prefer to attach a wear pad 33 to each tube, which presses against a pole being climbed.

When a user climbs a pole, the user places the first end 23 of the rope around the pole and attaches clip 25 to the middle portion of the rope such that the rope forms a loop around the pole. As a user climbs up the pole, the loop acts as a restraint to prevent the user from falling from the pole When the user reaches a particular position on the pole, the user may stop climbing to perform work at that position. When performing work on a pole, a user typically leans away from the pole to ensure the loop is in a tight, functional engagement with the pole so the user can easily maintain his or her position on the pole.

Preferably, the first strap 17 and second strap 15 extend to a position adjacent to and forward of the middle portion 6 of the belt 3 so that the position of the locking device 18 is forward to and adjacent to the middle of the belt. Such a position allows a user to easily see the locking device 18 so that the user can easily manipulate the locking device 18 or verify that the locking device 18 is in a locked or an unlocked position.

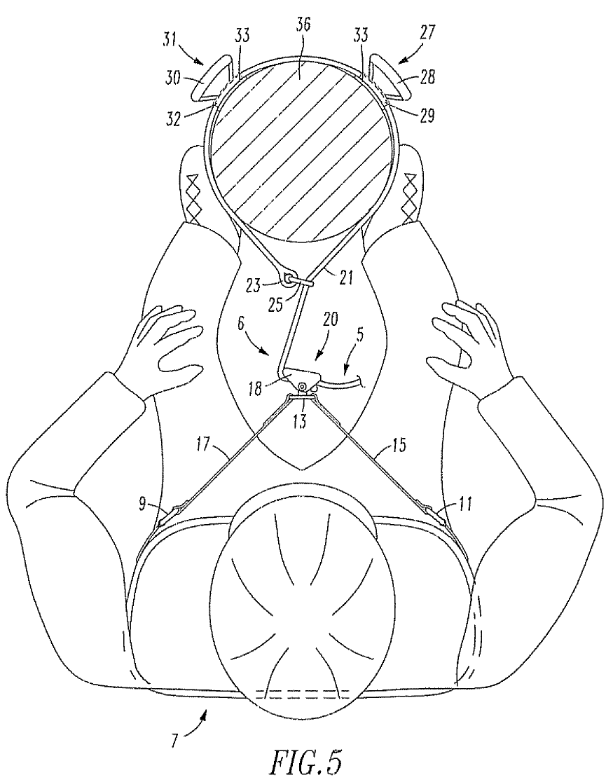

Most preferably, the first connector 9 and the second connector 11 are equidistant from the buckle 19 and the first strap 17 and second 15 strap extend a substantially equal distance from their respective connectors 9, 11 to position the locking device 18 adjacent to and forward of the front middle portion 6 of the belt. Such positioning ensures the stress from the rope and locking device is equally distributed on both sides of the belt so a user can work while maintaining a comfortable position, such as the position illustrated in FIG. 5, when on a pole 36. Pole 36 may be a tree trunk, a utility pole, or any other tall elongated body.

It should be appreciated that an equal distribution of force makes it easier for a user to maintain his or F her balance and position on a pole and prevents the user from assuming an uncomfortable posture while performing work while on the pole. For example, the equal distribution of force to both sides of the belt prevents a user from having to compensate for a disproportionate amount of stress that may be distributed along one of the two straps by leaning toward the other strap or talking some other corrective action to maintain a stable position while working on a pole.

The forward and central positioning of the locking device relative to the user also permits a user to easily see and operate the locking device without having to substantially move his or her body to see the locking device. A user working on a utility pole, for example, should only have to lower his or her head to observe the locking device to verify it is in the locked position or to see the locking device 18 when adjusting the length of rope 20 extending from a side of the locking device 18. Such a head movement is much simpler and requires much less movement than the movements required by the positioning of locking devices in other safety restraints, which often require the user to twist his or her head to the right or left to see the locking device.

The position of the locking device 18 of device 1 is maintained in substantially the same location so that a user can easily find the device or determine the location of the locking device. Other devices often have locking devices or rope connecting mechanisms that are moveable along the rope, belt, or harness so that a user must move his or her head in various, and sometimes uncomfortable, locations to see the locking device. The predictable or known position of the locking device 18 of device 1 helps to greatly reduce, if not eliminate, any concern the user may have regarding the locked or unlocked status of the locking device while working on a pole. For instance, a user should not have to male any substantial movements to find and observe the locking device 18 of device 1, which can alleviate, if not eliminate, some concerns a worker may have about verifying the setting of the locking device.

Handles 27 and 31 permit a user climbing a pole to climb at a quicker rate. Further, the handles permit a user to climb up or down a pole more efficiently than other devices. For example, a user need not waste energy attempting to grab part of the loop that surrounds a pole while climbing or descending to readjust the position of the loop, which is often difficult and time consuming because of the loop's tight engagement with the pole and the small diameter of the rope. The handles permit a user to easily readjust the position of the loop by grabbing the grasping members 28, 30 of the respective handles to pull the loop upwards or downwards to reposition the loop. Of course, a user may only need to grab one of the grasping members to effectively reposition the loop, which requires much less time and effort than attempting to grab a part of the loop. Moreover, the adjustability of the handles allows a user to alter the position of the handles 27 or 31 to make repositioning the loop easier. For instance, tubes 29 and 32 permit a user to slide one or both handles along the middle portion 21 of the rope away from or toward the first end 23 of the rope to place the handles in a desired position.

Wear pads 33 may be attached to the tubes to increase the durability of the handles The wear pads are preferably made of leather or canvas, but may be made of other materials as well. As may best be appreciated in FIG. 5, the wear pads are connected to the tubes so that the wear pads engage the pole being climbed by the user.

It should be understood that the teeth 26 of the cam 24 of the locking device 18 can be configured to permit the rope 20 to pass through the locking device 18 in a first direction when the locking device 18 is in the locked position, but prevent the rope from passing through the locking device in an opposite second direction. The first direction is preferably toward the first end 23 of the rope so that the user does not have to manipulate the locking device to obtain additional slack for the loop as lie or she climbs tip a pole. For such embodiments of my device, the second end 22 of the rope preferably has a large knot or stop that prevents the second end from passing through the locking device. Of course, other embodiments may have a locking device that prevents the rope from passing through any part of the locking device when the locking device is in the locked position.

The handles 27 and 31 may be interconnected by an adjustable fourth strap 34, as may best be seen in FIG. 2. It should be understood that other embodiments may have only one handle adjustably connected to the rope 20. In yet other embodiments, one handle may be adjustably connected to the rope and one or more non-movable handles may be affixed along the rope 20 such that the position of the non-movable handles cannot be adjusted.

The device 1 illustrated in FIGS. 1-5 and other embodiments of my pole climbing and full restraint device may be included in a full or partial body harness worn by a user climbing a pole or other tall elongated object. The device 1 and other embodiments may also be sold and worn separate from such harnesses Mien part of a harness, the belt 3 may be worn such that the belt is positioned at a user's waist, above a user's waist, or below a user's waist. For example, the belt 3 may be designed to be positioned on or below a user's buttocks when incorporated into a full body harness.

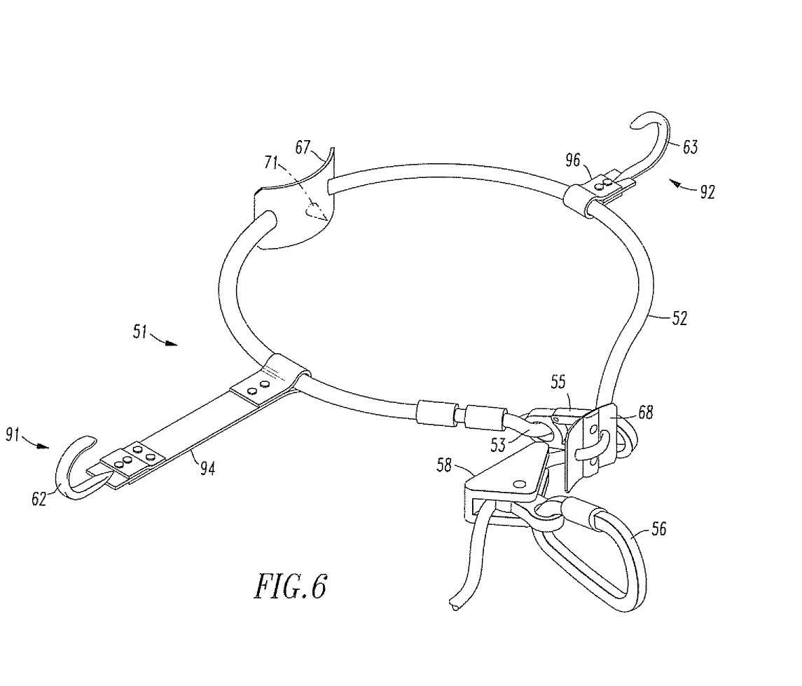

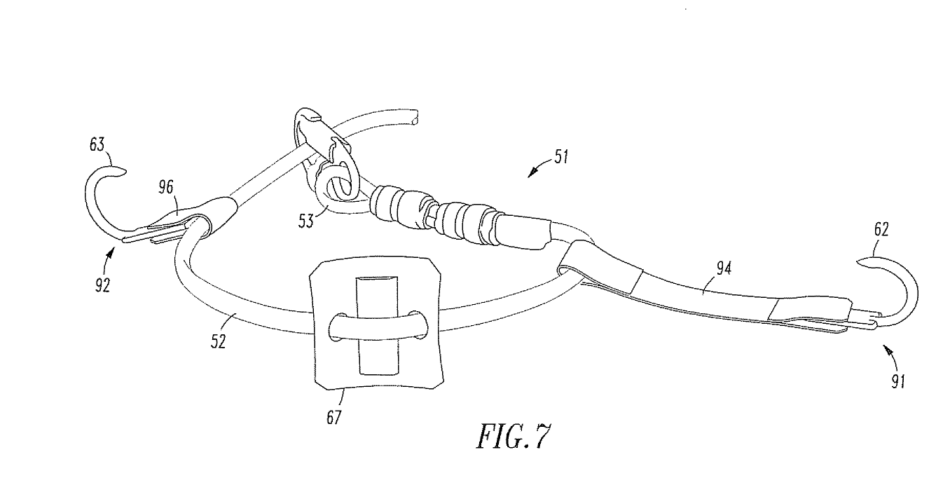

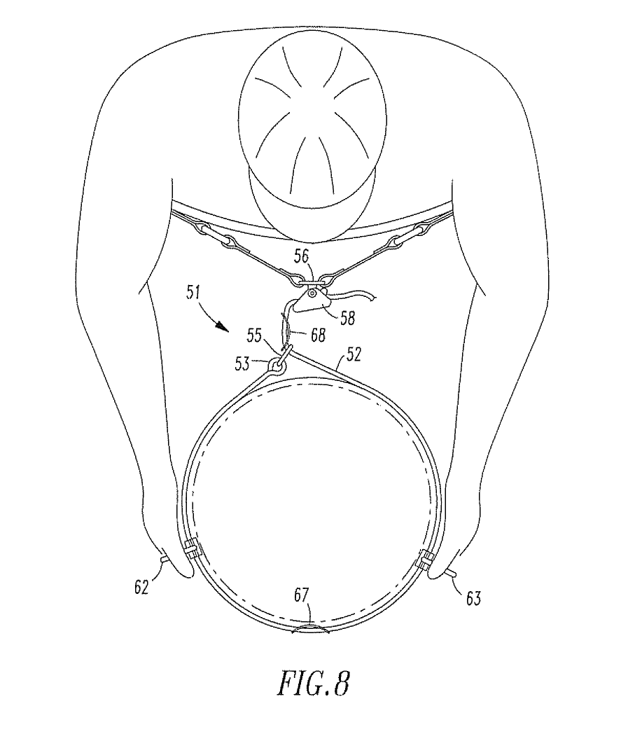

Referring to FIGS. 6-7, a second present preferred embodiment 51 of my pole climbing and fall restraint device is illustrated. Embodiments of my invention similar to the second present preferred embodiment 51 may be referred to as a lanyard apparatus. The lanyard apparatus includes a pole strap 52 that extends through a locking mechanism 58. The pole strap is sized and configured to adjustably wrap about a pole. The locking mechanism 58 is attached to a connector 56. Preferably, the connector 56 is a triple lock carabiner. The first end 53 of the pole strap 52 is attached to a coupling 55. A first handle 91 a second handle 92 are moveably attached to the pole strap 52. I prefer that the handles 91 and 92 include hooks, such as J-hooks, so that a user can easily slip his or her hand into the hook and keep the hook on the hand while climbing Other configurations, such as a loop could also be used. A first stop 67 and a second stop 68 are also moveably attached to the pole strap 52

The first handle 91 includes a first hook 62 and a strap 94 that attaches the first hook 62 to the pole strap 52. The connecting strap 94 extends from the pole strap 52 to the first hook 62. The strap attaches the first hook 62 to the pole strap 52 such that the first hook 62 may be rotated about the pole strap 52 and may also be slid along the pole strap 52. A user may slide or rotate the first hook 62 independently or at the same time. The connecting strap 94 positions the first hook 62 a first distance away from the pole strap 52. Preferably, the first distance is 8-13 inches.

The second handle 92 includes the second hook 63 and a strap 96 that attaches the second hook 63 to the pole strap 53. The connecting strap 96 extends from the pole strap 52 to the second hook 63. The strap 96 connects the second hook 63 to the pole strap 52 such that the second hook 63 may be rotated about the pole strap 52 and may also be slid along the pole strap 52. The sliding and rotating of the second hook may be done independently or in combination The connecting strap 96 positions the second hook 63 a second distance away horn the pole strap 52. Preferably, the second distance is 3-5 inches.

I have found that having both hooks positioned at different distances from the pole strap 52 helps a user readjust the pole strap 52 as the user climbs a pole Indeed, the hooks 62 and 63 allow a user to more easily move and readjust the pole strap 62 while climbing than handles 27 and 331, as may be appreciated from FIG. 8. For example, it has been determined that a user climbing a pole can more easily manipulate the pole strap 52 with hooks because the hooks permit a user to manipulate the pole strap 52 without tightly holding the hooks. Preferably the hooks are configured to open away from the pole or pole strap 52 when a user is lifting the hooks upward for climbing a pole Such, an orientation has been found to permit a user to easily place one or more fingers or the user's entire hand under the hooks to move the pole strap. Positioning the hooks away from the pole strap 52 by the connecting straps also permits a user to more easily find, move and grasp the hooks to adjust the position of the pole strap as the user climbs a pole.

The first stop 67 is positioned between the first hook 62 and the second hook 63. The first stop 67 is configured to help stop movement of the first and second hooks 62 and 63 along the pole strap 52 to prevent the hooks from both being positioned next to each other. Such a position has been found to help avoid situations where a user must readjust the position of one of the hooks or handles due to movement of both hooks to one side of a pole. Positioning the first stop 67 between the first and second hooks 62 and 63 can also help prevent a user having to grab around the pole in an attempt to find one of the hooks that may have moved while the user worked or readjusted his position on a pole.

The second stop 68 is positioned along the middle portion of the pole strap 52. The second stop 68 is adjustable along the length of the pole strap and can be used as a stop or parking tap to help prevent movement of the coupling 55 while the coupling is attached to the middle portion of the pole strap 52. By preventing such movement of the coupling 55, the second stop 68 can help prevent the pole strap 52 from becoming loosened in use so that a user stays wrapped about a pole he or she may be positioned on and is prevented from accidentally falling while the use works on a pole or climbs up or down a poles.

In some embodiments the first stop 67 may include an engaging device 71 that is configured to engage or pierce a pole or other structure that may be climbed. An engaging device 71 can be particularly helpful in ensuring the pole strap 52 is properly engaging a pole that may be slick due to ice, snow or other relatively slick condition. The engaging device 71 may include a nail, screw, bolt, hooks, a rough surface or at least one saw tooth. More than one engaging device 71 may be attached to the first stop 67. The engaging device 71 may also be used to help attach the first stop 67 to the pole strap 52. For instance, a portion of the engaging device may be used to secure a connecting strap to the pole strap 52 while a second portion of the engaging device projects past the pole strap 52 such that the second portion of the engagement device can engage a pole.

In some embodiments of the lanyard apparatus, the connector 56 or locking mechanism 58 may not be included. It is contemplated that such embodiments of my lanyard apparatus will be configured for attachment to a pole climbing belt, or harness or other belt device. A connector or locking mechanism configured for attaching the lanyard apparatus to the belt, harness or other belt device may be used to attach the lanyard apparatus to the belt harness or other belt device. It is also contemplated that a belt, harness or other belt device can include such a connector or locking mechanism.

The second embodiment 51 of my pole climbing and fall restraint device may also be provided in a kit Such a kit may include a belt device that is similar in construction to the belt device illustrated in FIGS. 1 and 3-5. Such a belt device can include the belt 3, first, second and third connectors 9, 11 and 13, and first and second straps 15 and 17, as shown in the belt 3 of FIGS. 1 and 3-5. The locking device may be provided with the belt device, the lanyard apparatus, or provided separately. The belt device, locking device and lanyard apparatus may be packaged together or packaged separately. Similarly, they may be sold together or sold separately.

It should be understood that rope 20 or pole strap 52 may be a lanyard, a cable, a wire, or other elongated member. The rope 20 or pole strap 52 may be composed of elastomers, synthetic fibers, natural fibers, leather, canvas or any combination thereof.

Of course, other variations of the present preferred embodiments discussed above may be made. For example, embodiments of my pole climbing and fall restraint device can include no stops, only one stop, or more than two stops. As another example, one hook or more than two hooks or other handles can be included in other embodiments of my pole climbing and fall restraint device.

While I have shown and described certain present preferred embodiments of my pole climbing and fall restraint device and pole climbing and fall restraint device kit and have illustrated certain present preferred methods of making and using the same, it is to be distinctly understood that the invention is not limited thereto but may be otherwise variously embodied and practiced within the scope of the following claims.

I claim:

1. A pole climbing and fall restraint device comprising:
an elongated member extending through a locking device, the elongated member sized and configured to adjustably wrap around a pole, the elongated member having a first end, a second end and a middle portion between the first end and second end;
a coupling attached to the first end of the elongated member, the coupling configured to releasably attach to the middle portion of the elongated member;
a first handle attached to the elongated member such that the first handle extends a first distance from the elongated member;
a second handle attached to the elongated member such that the second handle extends a second distance from the elongated member; and
wherein the first distance is greater than the second distance.

2. The pole climbing and fall restraint device of claim 1 wherein the first handle is comprised of a J-hook that is attached to the elongated member by a strap such that the hook configured to rotate about the elongated member.

3. The pole climbing and fall restraint device of claim 1 wherein the second handle is comprised of a J-hook that is attached to the elongated member by a strap such that the hook is configured to rotate about the elongated member.

4. The pole climbing and fall restraint device of claim 1 wherein the elongated member is a rope or wire.

5. The pole climbing and fall restraint device of claim 1 wherein the first handle is attached to the elongated member such that the first handle is moveable along the elongated member.

6. The pole climbing and fall restraint device of claim 1 wherein the second handle is attached to the elongated member such that the second handle is moveable along the elongated member.

7. The pole climbing and fall restraint device of claim 1 also comprising at least one stop attached to the elongated member.

8. The pole climbing and fall restraint device of claim 7 wherein the at least one stop is moveably attached to the elongated member.

9. The pole climbing and fall restraint device of claim 7 wherein the at least one stop is comprised of a first stop positioned between the first handle and the second handle.

10. The pole climbing and fall restraint device of claim 9 wherein the first stop, first handle and second handle are attached to the elongated member such that the first stop, first handle and second handle are moveable along the elongated member.

11. The pole climbing and fall restraint device of claim 7 wherein the at least one stop is comprised of a first stop positioned adjacent the middle portion of the elongated member.

12. The pole climbing and fall restraint device of claim 1 wherein the first stop is moveable along the elongated member and is sized and configured to help limit movement of the coupling when the coupling is attached to the middle portion of the elongated member.

13. The pole climbing and fall restraint device of claim 7 further comprising at least one engaging device attached to the at least one stop, the first engaging device configured to engage or pierce a pole.

14. The pole climbing and fall restraint device of claim 13 wherein the at least one engaging device is comprised of a nail, a screw, a bolt, saw tooth or a hook.

15. A pole climbing and fall restraint device comprising:
a belt having a front portion and a back portion;
a first connector connected to the belt;
a second connector connected to the belt;
a first strap extending from the first connector adjacent the front portion of the belt;
a second strap extending form the second connector adjacent the front portion of the belt;
a third connector connected to the first strap and the second strap adjacent the front portion of the belt;
a locking device connected to the third connector;
an elongated member extending from the locking device;
a coupling connected to the elongate member;
wherein the first strap extends a first distance from the first connector and the second strap extends a second distance from the second connector, the first distance and the second distance being substantially equal.

16. The pole climbing and fall restraint device of claim 15 wherein the elongated member has a first end, a middle portion and a second end, the coupling connected to the first end of the elongated member.

17. The pole climbing and fall restraint device of claim 16 wherein the coupling is configured to slidably retain a part of the middle portion of the elongated member when the coupling connects the first end of the elongated member to a part of the middle portion of the elongated member.

18. The pole climbing and fall restraint device of claim 15 wherein the belt is comprised of a buckle configured to adjustable fasten the belt about a user, the locking device connected to the third connector such that the locking device is positioned adjacent to and forward of the buckle.

19. The pole climbing and fall restraint device of claim 15 wherein the belt has a front middle portion and the locking device is connected to the third connector such that the locking device is positioned adjacent to and forward of the front middle portion of the belt when the belt is fastened.

20. A pole climbing and fall restraint kit comprising:
a belt device having a front portion and a back portion, the belt device comprising:
a first connector connected to the belt device,
a second connector connected to the belt device,
a first strap extending from the first connector adjacent the front portion of the belt,
a second strap extending from the second connector adjacent the front portion of the belt device,
a third connector connected to the first strap and the second strap adjacent the front portion of the belt device, and
a lanyard apparatus comprising.
an elongated member, the elongated member sized and configured to adjustably wrap around a pole, the elongated member having a first end, a second end and a middle portion between the first end and second end,
a coupling attached to the first end of the elongated member, the coupling configured to releasably attach to the middle portion of the elongated member;
a first handle attached to the elongated member such that the first handle extends a first distance from the elongated member;
a second handle attached to the elongated member such that the second handle extends a second distance from the elongated member, wherein the first distance is greater than the second distance; and
wherein the lanyard apparatus is configured to be connected to a locking device that is attachable to the belt device.
